(19) United States
(12) Patent Application Publication
(10) Pub. No.: US 2015/0066583 A1
(43) Pub. Date: Mar. 5, 2015

(54) CONTENT DISCOVERY WITH FRIEND AND ANALYTIC DATA

(71) Applicant: Google Inc., Mountain View, CA (US)

(72) Inventors: Sean Liu, El Dorado Hills, CA (US); Doug Sherrets, New York, NY (US); Marco Paglia, San Francisco, CA (US)

(73) Assignee: Google Inc., Mountain View, CA (US)

(21) Appl. No.: 14/017,532

(22) Filed: Sep. 4, 2013

(51) Int. Cl. G06Q 30/02

(52) U.S. Cl. CPC G06Q 30/0201
USPC 705/7.29

(57) ABSTRACT

A user may have difficulty making a decision about content such as whether to watch a particular content or determining whether the content is something in which the user will be interested. Disclosed are implementations directed to reengage a user in response to an abandonment event and/or provide analytic data to inform a user's decision regarding consumption of content. Analytic data may be provided to the user to help the user make a decision about what content to consume based on, for example, an abandonment rate or other user metrics that indicate interest or disinterest in certain content.

### BACKGROUND

When browsing content, such as a website, a book, an album, a video, etc., a user may be interested in viewing or sampling an excerpt of the content to evaluate the content or determine if it will pique the user's interest. Some content providers offer content recommendation services that suggest content a user may be interested in based on the user's purchase history or browsing history. Many of these systems, however, do not provide specific portions of content for a user to sample based on the user's interests or online behavior (e.g., purchase history, browsing history, etc.) as a component of a recommendation.

In some instances, a user may begin to consume content and decide that it is uninteresting or otherwise not worth continuing. For example, a user reading a book may enthusiastically read the first few chapters, but that enthusiasm may wane mid-way through the book. At this point, the user may decide to abandon the book or not finish reading the book because the user does not have any reference to gauge what the user's potential interest might be in the remaining chapters of the book.

### BRIEF SUMMARY

According to an implementation of the disclosed subject matter, a user profile corresponding to a user may be obtained. A selection of content may be received based on a recommendation. An indication of an abandonment event may be received. Based on the abandonment event, analytic data may be selected. The analytic data may indicate a likelihood of continued consumption of the content by users having profiles similar to the user profile. The analytic data may be provided or presented to the user.

In an implementation, content may be segmented into one or more segments based on a predetermined interval. Analytic data for each of the one or more segments may be determined. A selection of content may be received from a user associated with a user profile. A request for analytic data corresponding to a portion of the one or more segments may be received. A position of the user in the content may be determined. Responsive to the request and based on the user position in the content and the user profile, the analytic data may be provided or presented to the user.

A system is provided in an implementation that includes a database and a processor communicatively coupled to the database. The database may store at least one user profile. The processor may be configured to obtain a user profile for a user from the database. It may receive a selection of content based on a recommendation and an indication of an abandonment event. Based on the abandonment event, the processor may be configured to select analytic data, that indicates a likelihood of continued consumption of the content by users having profiles similar to the user profile. The analytic data may be provided or presented to the user.

In an implementation a system is provided that includes a database for storing analytic data and a processor communicatively coupled to the database. The processor may be configured to segment content into one or more segments based on a predetermined interval. It may determine analytic data for each of the one or more segments and receive a selection of content from a user associated with a user profile. The processor may receive a request for analytic data corresponding to a portion of the one or more segments and determine a position of the user in the content. Responsive to the request and based on the user position in the content and the user profile, the processor may be configured to provide the analytic data.

A method is provided in which content may be segmented into one or more segments based on a predetermined interval. Analytic data for each of the one or more segments may be determined. A recommendation may be generated for content for a user based on a user profile. Analytic data may be presented as a component of the recommendation. The analytic data may include a graphical representation of a completion rate for each of the one or more segments.

In an implementation analytic data for content may be obtained. A user profile for or corresponding to a user may be obtained. Content may be provided to the user. An indication of a decision from the user may be received. A portion of analytic data may be selected based on the user profile, the content, and the indication of the decision. The portion of the analytic data may be provided or presented.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 is an example method for providing analytic data based for segments of content based on an abandonment event.

FIG. 4 is an example method for providing analytic data based for segments of content based on a user profile.

FIG. 5 is an example system for providing analytic data based on a recommendation and an indication of an abandonment event.

FIG. 6 is an example of a system that includes a processor and a database that are used to provide analytic data.

FIG. 7 is an example of a method to segment content into a predetermined interval and provide analytic data to a user as a component of a recommendation.

FIG. 8 is an example of a method to provide analytic data to a user based on a receipt of an indication of an abandonment event.

FIG. 9 provides examples of analytic data that has been selected and provided to a user for various forms of content.

FIG. 10 is an example of a presentation style of analytic data for a movie.

FIG. 11 is an example of window that may appear and provide analytic data upon detection of a user action or abandonment event.

FIG. 12 is an example of analytic data that may be provided to a user based on the user profile.

FIG. 13 is an example of a completion percentage for a book.

FIG. 14 is an example of a completion rate for a movie.

FIG. 15 is an example a completion percentage for a song.

FIG. 16 is an example of a graphical representation of a completion percentage for a book or movie.

### DETAILED DESCRIPTION

A user may have difficulty making a decision about content such as whether to watch a particular content or determining whether the content is something in which the user will be interested. As described above, analytic data may be provided to the user to help the user make a decision about what content to consume based on, for example, an abandonment rate or other user metrics that indicate interest or disinterest in certain content. There may be a difference between a user's initial decision to consume content and the user's mindset once consumption of content has begun. For example. a movie trailer may entice a user to view a movie, but the user may find that the movie is not entertaining midway through it.

Implementations disclosed herein may relate to providing information to a user that indicates a completion rate of content by other individuals consuming the same content. Each of the other individuals may be a consumer of the same content, or a member of a subset of individuals such as a friend group or social network group. For example, a user may be interested in movie X. The user may be presented with a graphic that indicates the completion rate of other people who watched the entirety of movie X or a section of the movie. This may indicate, for example, that certain segments of the movie may not be particularly interesting. In addition, the completion rate may be shown based on a particular user or something known about the user. For example, if the user is taking a trip to London and the movie the user is watching has an upcoming scene involving London, that particular scene may be highlighted for the user as an excerpt or preview.

As another example, a user may receive an indication of parts of a book that have been actually read by other people (or friends in the user's social network). This may indicate to the user that people tend to skip specific sections of a book. One such indication may be based on the amount of time a group of users spent viewing each page or chapter. This may indicate that a part of the book may not be especially important and may have caused many people to abandon the book, i.e., not to read the remainder of the book. Similarly, a user may receive an indication that many people spent a significant amount of time on a specific part of the book, suggesting that people may have studied the content therein carefully.

In an implementation, content may be highlighted based on excerpts that have been shared. For example, several individuals may share a paragraph of a book. A user, when viewing the book, may receive an indication that the specific portion of the book has been shared by a number of individuals. The indication may be provided in the form of highlighted text in the case of a book (e.g., bold type, underlined, circled, etc.) or other visual or audible indicator for other types of digital content.

Content may be divided into portions, such as ten second segments for audio/video content, three pages for a book, pixels for vertical scroll of a website, or any other such increment (e.g., a chapter, a scene, a paragraph, a frame, etc.). The percentages of content consumed by people who have completed consumption of the portion may be determined. In some instances, the data may be smoothed to minimize noise due to, for example, sparse data.

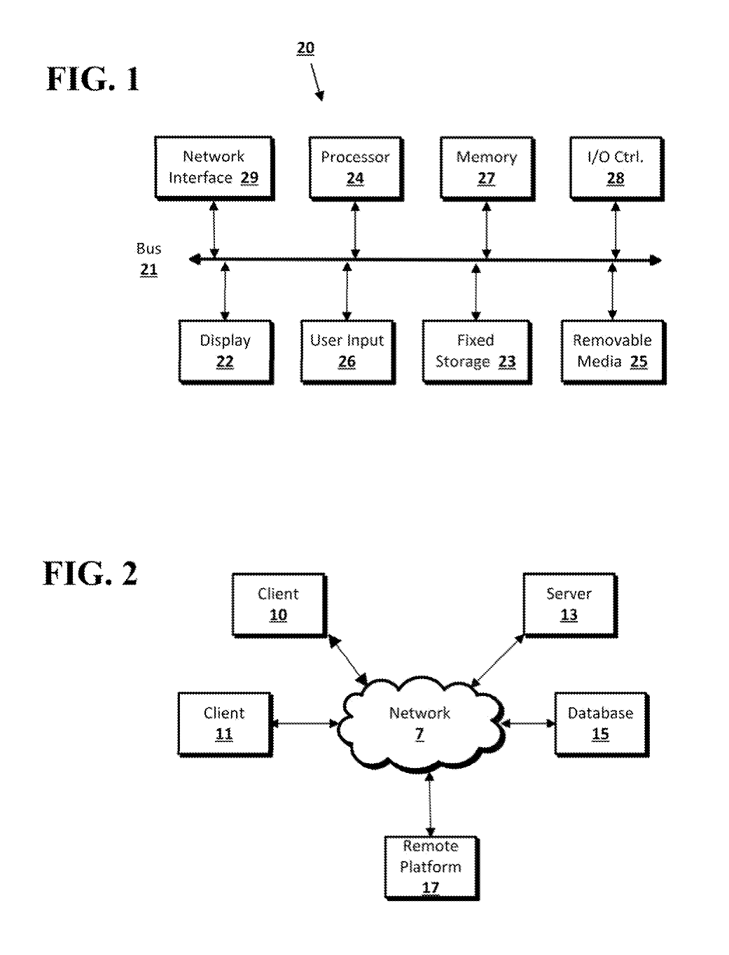

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

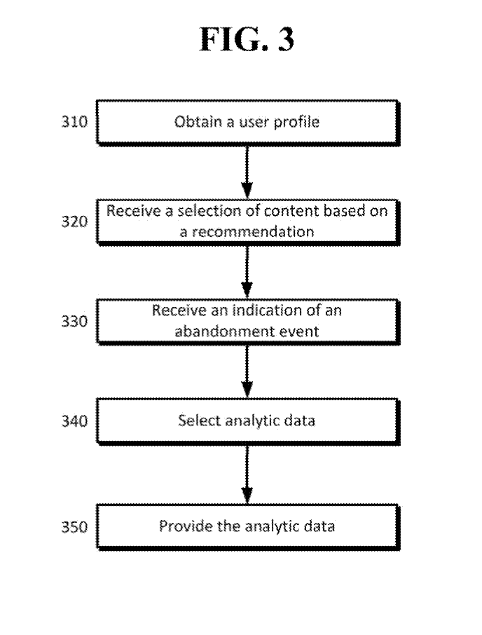

According to an implementation, an example of which is provided in FIG. 3, a user profile for a user may be obtained at 310. A user profile may be stored on a server or database and may contain information about the user such as a user name, an email account, a user account, a browsing history, a purchase history, a location of the user, characteristics of the user, and personal preferences of the user. A browsing history may refer to products or content that a user has viewed on a web site, for example. It may include the length of time that a user viewed information about content and/or what type of information about the content the user browsed. For example, a content provider may provide a web page that includes information about a movie such as movie trailers, screen captures from the movie, a brief description about the movie, and cast information. A browsing history may include the length of time that a user has viewed the content itself For example, a user may watch a trailer or five minute preview of a movie on a website. The user's consumption of the portion of the content may be included as a component of the user profile.

A purchase history may refer to a record of any content or products actually purchased by the user. A location of the user may be obtained from a user's IP address or it may be entered by the user. Characteristics of the user may refer to a user's online behavior. For example, it may refer to the time of the day that a user typically accesses a web site. Personal preferences of the user may refer to a user's desired configuration of a web site. For example, a user may prefer to have advertisements provided to the user's email address or shown to the user while visiting a particular web site. A personal preference of the user may refer to a user's desired appearance of a particular web page (e.g., a theme, or what content is displayed on a web page).

A user profile may be generated when a user attempts to access or purchase content on a web site. For example, a user may be prompted to create a user account that has a user name and/or password. Any activity the user undertakes or performs (e.g., browsing, purchasing, and selecting personal preferences) may be stored as a data record and associated with the user profile of the user, including the user account itself. The use profile may be stored in a remote database and accessible therefrom by a processor communicatively coupled to the database.

A user profile may be clustered or grouped with other users whose profile contains similar elements. For example, users who are associated with having an interest in Victorian romance novels may be grouped together. Techniques for clustering user profile data are known by those of ordinary skill in the art. A single profile may be present in multiple clusters. For example, a user may have an interest in Victorian romance novels and adventure movies. The user's profile may be associated with both categories. A category may be defined and user profiles may be selected to be associated with the category based on the data contained in the user profile (e.g., browsing and/or purchase history). Categories may be further refined and user profiles may be selected based on an intersection of data contained in the user profile. For example, a user's age may be used to further define subcategories within adventure movies.

Data regarding content (e.g., movie, book, song, album, etc.) may be collected, stored, arranged, configured, etc. by an existing system designed to construct a knowledge graph, as would be understood by one of skill in the art. For example, determining that Movie X has a style similar to Hitchcock films, or that books A, B, and C are in the same genre may be performed according a method known to one of ordinary skill in the art.

[43] A selection of content may be received based on a recommendation at 320. For example, a content provider may generate a recommendation of content to a user based on the user profile. As a specific example, a user may be particularly interested in World War II (“WWII”) based on a browsing history that indicates the user has viewed multiple WWII documentaries, 20th-century history programs, and the like. The content provider may suggest a WWII movie that the user has not yet browsed or purchased. The recommendation may be based on what content other users with a similar user profile (e.g., WWII documentaries) have viewed or consumed, what content has been popular or rated highly, or combinations thereof. A user may make a selection of the content recommended to the user by the content provider. For example, the user may select a movie recommended by the content provider using a keyboard and/or mouse.

An indication of an abandonment event may be received at 330. An abandonment event may refer to an action that could be interpreted as the user no longer pursuing consumption of content being provided. For example, an indication of an abandonment event may be a pause, a window close, or a browser action (e.g., selecting a “back” button or the like that would allow the user to leave a web page). In some instances, such as reading book, the user may pause over a particular passage for an inordinately long time based on the user's typical reading habits or behavior. The pause may be determined to be the user losing interest in the book. Likewise, a camera associated with a computer with which the user consumes content may be used to detect the user's presence or eye movements. For example, the camera images may be used to determine that the user is looking away from the computer screen for a period of time. The period of time may be a minimum threshold of time beyond which an abandonment event is deemed to occur. The camera data may be used to determine the user's facial expressions and this may be used to gauge the user's interest. A microphone may be used to determine the user's interest. For example, if the microphone detects a user sighing multiple times within a predefined interval of time, the user may be deemed to be disinterested or losing interest in the content. As another example, if it is determined that the user is speaking to another person for more than a trivial amount of time, it may be determined that the user has ceased paying attention to the content. Thus, both user actions and visual and audio cues that may be automatically detected may be used individually or in combination as an indication of an abandonment event (e.g., that the user is no longer interested in pursuing consumption of the content).

Based on the abandonment event, analytic data may be selected at 340. The analytic data may indicate a likelihood of continued consumption of the content by users having profiles similar to the user profile (i.e., the user from which an indication of an abandonment event was detected). Analytic data may refer to a completion percentage of content consumption by one or more users, a completion percentage for one or more segments of the content by one or more users, a satisfaction rating, and/or a click-through metric. The analytic data may be provided to the user at 350. For example, a user may have selected a documentary recommended to her. The user may watch 25 minutes of the documentary and decide that she is losing interest. The user may select the back button on the web browser that she is using to view the content. Analytic data for the documentary the user is viewing may be selected based on the user profile, indicating an age for this user and other individuals whose user profiles have been clustered into a group that likes documentaries that are related. Related documentaries, for example, may be based on data represented by a knowledge graph such as a genre, a director, an actor, etc. The analytic data may indicate, for example, that 45% of users similarly grouped as the user completed viewing the entire movie. As another example, the analytic data may show users' ratings of the upcoming scenes in the movie. The analytic data may be presented as a graphical representation that appears in a user's web browser. Other examples of analytic data and types of textual and/or graphical representations thereof are provided below.

Analytic data may be based on an action of the user. For example, a user may finish reading the first four chapters of a book and the analytic data may be selected for the remaining 6 chapters of the book. The selected data may indicate that other users who read the same book and for whom an abandonment event was detected at the end of or during chapter four skipped chapters 5-7 and resumed reading at chapter 8, and that the same users also completed reading the book from that point onward 75% of the time. In some configurations, content may be purchased by segments. For example, a book may be purchased by chapter or a television series may be purchased by episode. The analytic data selected and provided to the user may be based on a user's decision to consume a portion of the content and then pause or stop consuming the content for a period of time (e.g., a user hasn't viewed a new episode in several months). Similarly, it may be selected and provided subsequent to the user making an explicit decision to cease consuming content, such as where the user indicates that he does not wish to purchase the next portion of the content.

In some configurations, a decision from the user may be received. For example, upon learning that a majority of individuals read the last five chapters of a book the user is reading, the user may elect to skip ahead to those chapters in order to avoid seemingly mundane ones. The user's decision to skip ahead may be stored and incorporated into the analytic data for future users. That is, a user's decision or action upon receiving analytic data may be used to modify the analytic data for a subsequent user. The user's decision or action may be utilized to modify the user's profile. For example, a user's decision to opt out of continued viewing of a movie after being provided the analytic data may be used to modify the user's profile to indicate that the user is less likely to be interested in content from the same director, or that the user is more/less interested in scenes that have a significant number of cuts in a scene. As an example, an action sequence may have more cuts in a scene as compared to a scene that primarily is focused on a dialogue between two actors. A user's preference of the relative number of cuts in a scene may be incorporated with the analytic data and/or organized as a component of a knowledge graph. Analytic data also may be provided in response to a user's decision to skip a portion of content, such as where a user moves forward in a film without viewing the intervening portions, or skips one or more sections of a book. For example, the user may be informed of a percentage of users with similar preferences, browsing histories, purchasing histories, or the like that viewed the skipped portion and/or rated the skipped portion relatively highly.

In some configurations, the analytic data may be selected based on a user's social network. A social network may refer to a collection of individuals or groups that are associated or interconnected with a user based on the user's personal interests, communications, or other information typically contained in a user profile. A social network associated with the user may be determined. For example, a user's contacts, friends, friend groups, etc. may be obtained from the user herself, a social network account, the user's email account, etc. Analytic data may be selected based on how the user's friends from the social network acted for the same content. For example, a user's friends may have viewed the same movie or even recommended the movie to the user. Upon detecting an abandonment event, analytic data from the user's friends may be obtained and provided to the user. It may inform the user that most of her friends finished watching the movie. In some configurations, the user's friends may enter a comment or rating for the movie. A comment may be analytic data and may be provided to the user.

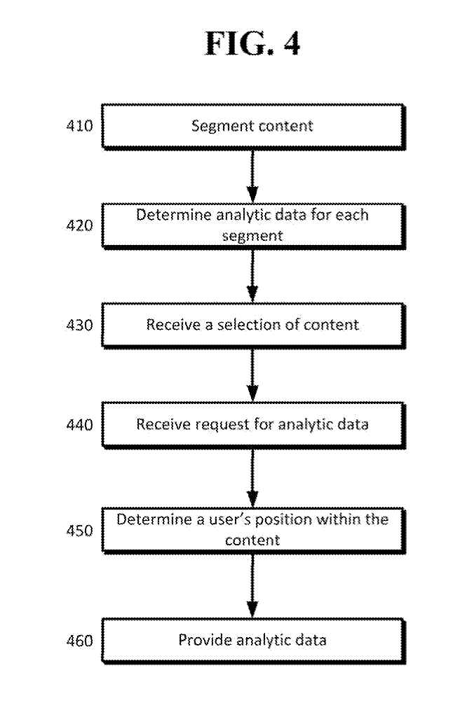

In an implementation, an example of which is shown in FIG. 4, content may be segmented into one or more segments based on a predetermined interval at 410. Examples of a predetermined interval includes: a chapter, a scene, a page, a predetermined time, and a paragraph. For example, a book may be segmented by paragraphs or chapters. Segmentation of content may be configurable by a content provider. In some instances, it may be necessary to create an artificial segmentation based on time. For example, certain forms of content consumption are continuous (e.g., viewing a movie) and are not necessarily easily divided. A content provider may segment the video into ten second intervals and analyze user behavior for each interval to generate the analytic data. Thus, analytic data for each of the one or more segments may be determined at 420. For each segment, analytic data may be collected for users consuming the content. It may indicate that 70% of users abandon reading a book after paragraph ten of chapter four or chapter four itself and never return to the book. Analytic data may be determined for a user's social group or network as described earlier, for example, to indicate that 70% of a user's friends abandoned a book after paragraph ten of chapter four. In some configurations, a first user may elect to share analytic data obtained from the first user's actions such that other users, such as those in the first user's friend group, may be able to view the analytic data obtained from the first user. For example, other users may be able to see what portions of a book or movie the first user found interesting or boring by observing what chapters of a book the first user skipped or what scenes of a movie the first user watched repeatedly.

A selection of content from a user associated with a user profile may be received at 430. Content may refer to audio, video, applications, books, etc. A selection may be received, for example, when a user selects a movie to view using a web browser interface or the like. Once the selection is made, the content may be provided to the user via the interface.

A request for analytic data corresponding to a portion of the one or more segments may be received at 440. For example, a user may select a book to read. A user's position within the content may be determined at 450 so that the appropriate analytic data for the remaining content may be selected and provided to the user. For example, a user who has read the first ten chapters of a book may not be provided with analytic data for those ten chapters except as a baseline (e.g., other users who have read the first ten chapters continued to read the remainder of the book 80% of the time). Analytic data may be constantly collected, updated, and stored, based on the actions of users consuming a given content. However, only a portion of the analytic data may be shown to the user for the given content based on the user's profile, the user's position within the content, the user's social network, etc. A request for analytic data may be sent to a processor connected to the database that stores or has access to the analytic data that has been and is being collected. The request may be sent when an abandonment event is detected, for example, as described earlier. The request may be sent from an electronic device from which a user accesses the content.

Responsive to the request and based on the user's position in the content and the user profile, analytic data may be presented or provided at 460. Upon receiving a request for analytic data (e.g., from a user's device), the relevant analytic data may be selected and/or provided to the user. As an example, the user may be finished with chapter ten of a book and be interested in knowing how upcoming chapters of the book have been received. Analytic data may be presented to indicate user ratings for each of the upcoming chapters and what percentage of users read each upcoming chapter through completion. For any implementation disclosed herein, a presentation style for the analytic data may be determined and/or selected. In some instances, it may be useful to provide a graphical representation of the analytic data to a user while in other cases it may be better to have a single line of text display the relevant data. The user's decision subsequent to providing the analytic data may be detected, stored, and used to modify the analytic data and/or the user profile as described earlier.

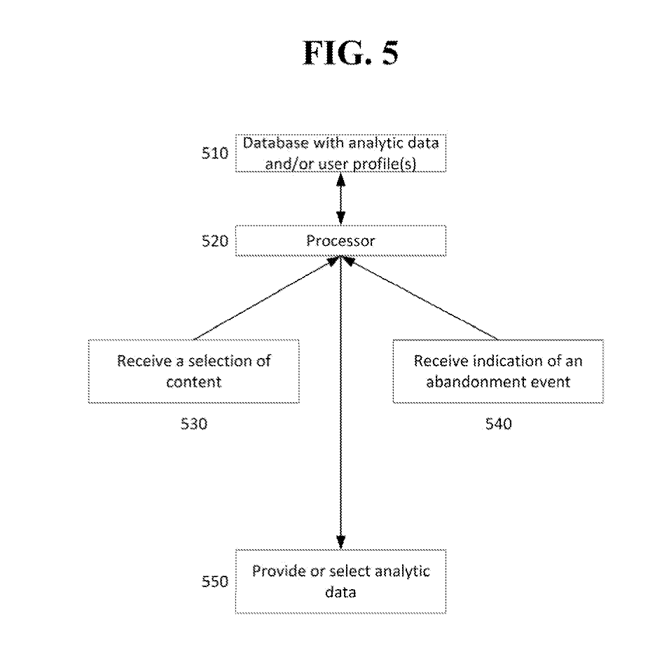

In an implementation, a system is provided that includes a database that communicatively coupled to a processor as shown in the example system in FIG. 5. The database may store at least one user profile and/or analytic data 510. The processor 520 may be configured to obtain a user profile for a user from the database 510. As described earlier, a user profile may contain information about the user such as the user's browsing history or purchase history. The processor may receive a selection of content 530 based on a recommendation and receive an indication of an abandonment event 540. A content provider, as stated above, may provide recommendations to a user based on a user profile. A user may select one of the recommended content items, initiating consumption of the content. In some configurations, the database may also provide the content selected by the user while in other configurations, the content is provided by a separate system/database. Based on the abandonment event, the processor may select analytic data 550.

The analytic data may indicate a likelihood of continued consumption of the content by users having profiles similar to the user profile. For example, user profiles may be clustered into groups based on a user's determined interest in various topics. A user may be ranked among such groups to indicate a user's preferred interests. A user may be interested in science fiction novels, entrepreneurship documentaries, Alfred Hitchcock, and music from Vivaldi. These may be the highest ranked interests for the user. The user may have a demonstrated interest in these categories based on the user's browsing and/or purchase history, for example. Thus, the user may be recommended content similar to entrepreneurship documentaries or Hitchcock's style based on the user's interest therein. If the user is viewing a entrepreneurship documentary, analytic data may be selected based on other users that are also aficionados of entrepreneurship documentaries. It may also narrow the pool of analytic data to users who have been pooled into both the entrepreneurship documentary and science fiction novel categories where relevant. For example, the entrepreneurship documentary may focus on a historical entrepreneurship figure that has an interest in science fiction novels. The processor may provide the analytic data to the user. As described earlier, the processor may receive a decision from the user subsequent to providing the analytic data to the user or user's device. The result of that decision may be utilized to modify the analytic data and/or the user profile.

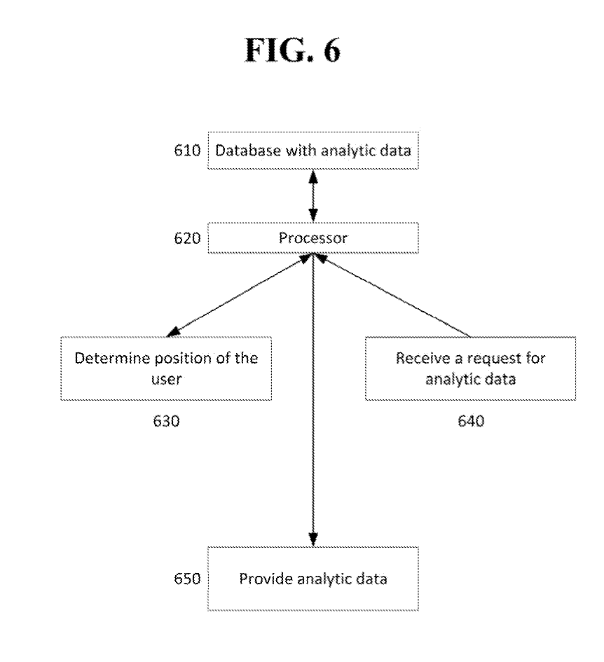

In an implementation, a system is provided that includes a database 610 for storing analytic data and a processor 620 communicatively coupled to the database 610. An example of such a system is provided in FIG. 6. The processor 620 may be configured to segment content into a plurality of segments based on a predetermined interval as described earlier. A position of the user in the content may be determined 630. For example, a user may be determined to be fifteen minutes into viewing a movie, in scene ten of the movie, or in paragraph seventy eight of chapter five of an electronic book. The position of the user within the content may be conveyed to the processor or hardware connected thereto. In some configurations, a request for analytic data may be received 640. Responsive to the request and based on the user position in the content and the user profile, analytic data may be provided 650. For example, the request may be for analytic data for chapters six through ten of a book because the user has read the first five chapters. The user profile may indicate, for example, an age of the user or similar demographic. Based on the user's demographic and position in the book, analytic data for other users that have a similar demographic for chapters six through ten.

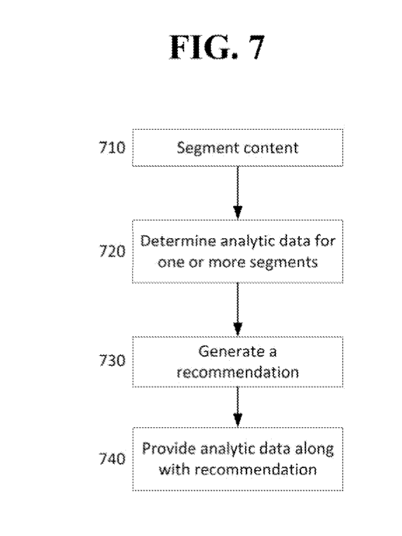

In an implementation, an example of which is provided in FIG. 7, content may be segmented into one or more segments based on a predetermined interval at 710 as described earlier. Analytic data may be determined for each of the one or more segments at 720. A content provider may note users' behavior for each of the segments for one or more content items. For example, a content provider may segment movies A, B, and C into ten second intervals and detect or score users' behavior for each of the movies for each ten second interval. Users' behavior may be, for example, the number of users that finished viewing a ten second segment, the number of users who paused the video during a ten second segment, etc. A recommendation for content for a user may be generated based on a user profile at 730. As described earlier, a user who is interested in WWII documentaries based on the user's purchase and/or browsing history may receive recommendations related thereto. As a component of the recommendation, analytic data may be presented or provided at 740. The analytic data may include a graphical representation of a completion rate for each of the one or more segments. For example, a user may be recommended documentaries A, B, and C and next to each documentary, a graph showing the completion rate for other users who are interested in WWII documentaries and who are in the same demographic as the user may be presented. Examples of such graphs are described and shown in more detail below. In some configurations, a different presentation style for the analytic data may be selected (e.g., a textual representation for the analytic data).

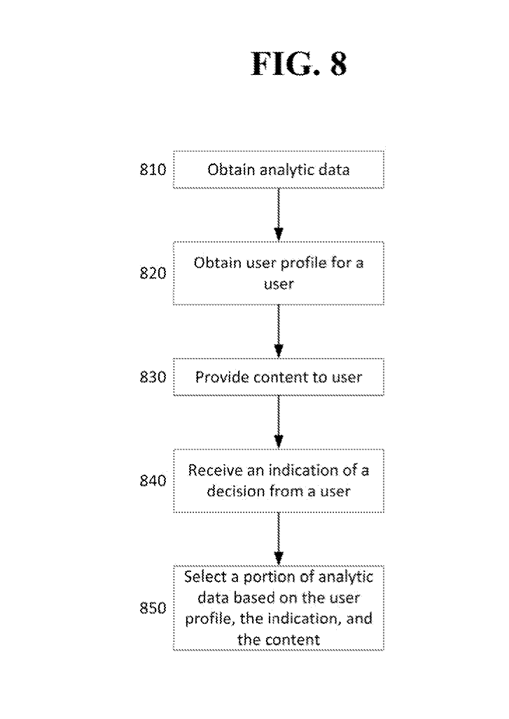

In an implementation, an example of which is provided in FIG. 8, analytic data for content may be obtained at 810. Analytic data may be stored in a database. It may be processed and/or updated in real-time or substantially real-time by a processor connected to the database. A user profile for a user may be obtained at 820 as described earlier. Content may be provided to the user at 830. In some configurations, one system may provide content to a user's computing device while another system may manage analytic data and/or providing the analytic data to the user. An indication of a decision from a user may be received at 840. For example, a decision of a user may be an abandonment event as described earlier, a comment generated by the user regarding the content, opening a new browser window or tab, etc. A portion of analytic data may be selected based on the user profile, the content, and the indication of the decision at 850. For example, a user electing to close a browser window containing a movie (e.g., content) that is being provided may signal the user's disinterest in the content. Analytic data may be provided to the user's computing device for display to the user to indicate that the majority of users with a similar user profile finished viewing the movie 95% of the time and those same users rated the movie as a four out of five stars (five stars being a “perfect” rating).

As disclosed herein, graphical representations may be provided to a computing device belonging to a user consuming content to indicate a completion rate of content by other users, the user's friends (or social network), or other subset of the total individuals consuming that particular content. The graphical representation may include a presentation of the completion rate of consuming an entire piece of content or a portion thereof. This may reveal, for example, that certain portions of the content may not be particularly interesting to a particular user. It may indicate that other individuals tended to skip over certain parts of a book, as indicated by the length of time the other users viewed a particular page or passage of the book. A user, upon being presented this information, may realize that a middle portion of the book may not be particularly important to the overall story or that interesting. This may cause the user to abandon reading the book or to skip the middle portion of the book, or to continue reading past the less-consumed portions of the book to reach the “more interesting” portions. It may allow the user to ascertain significant portions of a book.

For example, analytic data may indicate that users spent a significant amount of time for a particular portion or passage of the book. One such method of obtaining this information may be determining a user's average time to read a page of a book. The user's actual time for completing a page of a book may be compared to the average time. It may be determined if the user's actual complete time represents a significant deviation from the user's completion time or if the user exceeds a threshold for completing a given page. Similarly, an average completion time may be computed for a group of individuals who consumed a portion of content and the user's actual completion time for the same portion of content may be determined and compared to one another.

In some configurations, content may be highlighted from excerpts that have been shared between one or more users. For example, a user may receive a book recommendation from a friend and that recommendation may include an excerpt of the book that may be highlighted for the user. An instance of sharing a portion of content between two or more individuals may be stored in a database. A user may be presented with analytic data which indicates what portions of content are the most shared, for example, or the most shared by other individuals who have a similar user profile to the user.

In an implementation, content may be segmented based on time, page, paragraph, scene, etc. The percentage of content consumers who have completed consumption may be determined. In some configurations, the data may be smoothed to remove sudden fragment drop-off. For example, the data may be passed through a low-pass filter which may blur spikes in the analytic data. The analytic data (either raw or smoothed) may be provided or exposed to a user depending on the user and the content the user is consuming. In some instances the analytic data that is presented may be ranked based on what completion data is determined to be relevant to the user. For example, the analytic data may be based on a click-through rate for those novels that resulted in user satisfaction according to completion statistics. For example, if a user is browsing books to potentially read, a recommendation may be generated based on the completion statistics for a subset of books that has been selected according to the user profile of the particular user.

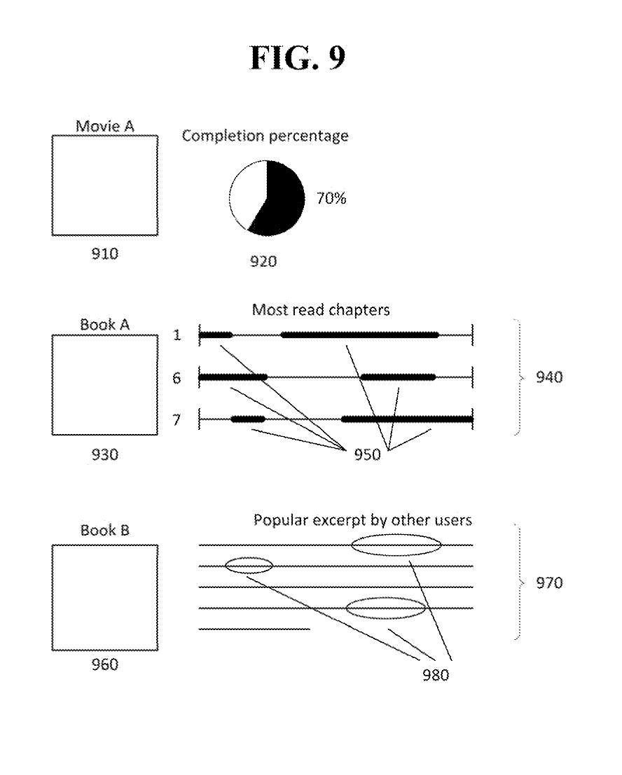

FIG. 9 shows examples of analytic data shown beside content. Movie A may represent a movie that has been recommended to the user or that the user is otherwise viewing. It may be accompanied by a thumbnail image 910, for example, that shows a picture from the movie or other promotional material. A completion percentage may be shown textually, as indicated by the “70%,” and/or graphically, as indicated by the pie chart 920. The analytic data shown here may be modified from showing the completion percentage of all users who viewed the movie to a subset of users as described earlier (e.g., showing the completion percentage of only people in the user's friend group). Book A may be shown along with its cover or other promotional material 930. The most frequently read chapters may be displayed as lines 940 and the most read portions of those chapters may be highlighted 950. In the example, provided, the bold lines highlight the most read portions of the chapter. A user seeing these data may be interested in skipping to those portions of the chapters shown to ascertain whether or not the user will be interested in the book. In some instances, the highlighted portions of the chapters may be used to indicate which portions of those chapters a particular user may be interested in reading. For example, if a user is planning a trip to London to see friends, an indication of that trip may be received by the user's calendar, or the user may have booked plane tickets to London and received confirmation that is available in the user's email account. The highlighted portions of the book may contain a scene or mention London and thus, may be of interest to this particular user.

Book B is shown in FIG. 9 with promotional material (e.g., an image) 960 and the analytic data shown with it is an excerpt from the book 970. The excerpt may be selected, for example, because it is the most shared portion of the book, it is relevant to the user, or because it is the most read portion of the book. The circled portions of the excerpt 980 may highlight text that is of interest to the user. Continuing the example above, the circled portions may mention London or locations in London. The circled portions of the excerpt 980 may highlight text relevant to a user search query. In some implementations, a reading time may be adjusted for comparability based on, for example, syllables, reading level of a given word, a subject matter (e.g., math compared to fiction). A particular section of a book, such as a summary or one of the best points of the book, may cause a given user to return regularly such as every day or every week to re-read the same content.

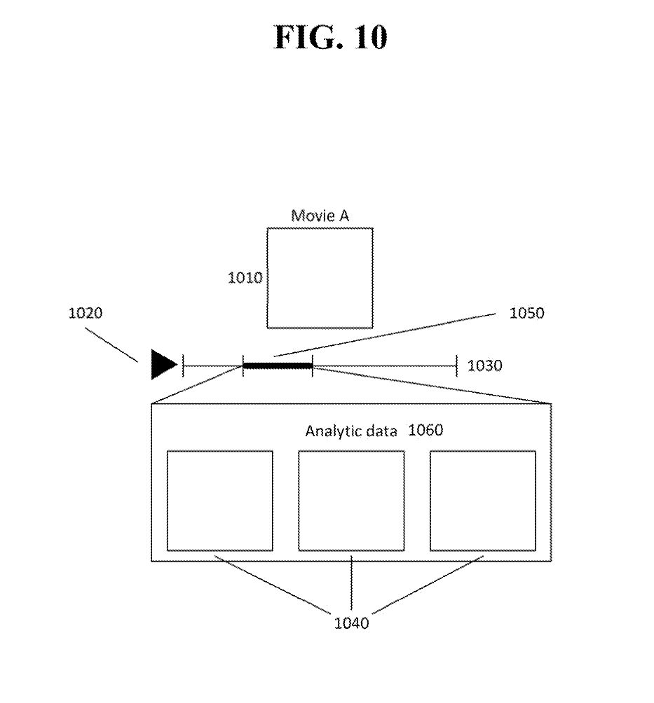

FIG. 10 shows an example of a presentation style of analytic data. Movie A may be presented to the user as a component of a recommendation or the user may be playing Movie A. An image or video of the movie (e.g., the movie itself) may be presented in the window shown 1010. The progress bar shown beneath the movie 1030 may contain an indicator to reflect where a user is within that content. It may include a control for a video player 1020 that may allow an operator to play, stop, or pause the content, for example, shown in the window 1010. In some configurations a portion of the progress bar may be highlighted 1050 based on a selection of analytic data. The analytic data 1060 may show screenshots from the segment of the movie. For example, the analytic data 1060 may show an abandonment rate for users or a completion rate for users. The portion of the movie 1050 may have been selected because the abandonment rate or completion rate was unusually high. Display of the 1060 analytic data may be automatic or in response to a user request to view it. For example, a user may select the highlighted portion of the progress bar 1030 to cause the display of the analytic data 1060. Likewise, the highlighted portion 1050 may appear in different colors to indicate a completion percentage among a group of users (e.g., user's connected to a user's friend group or social network). For example, a red color may indicate a high user abandonment rate while a green color may indicate a high completion percentage.

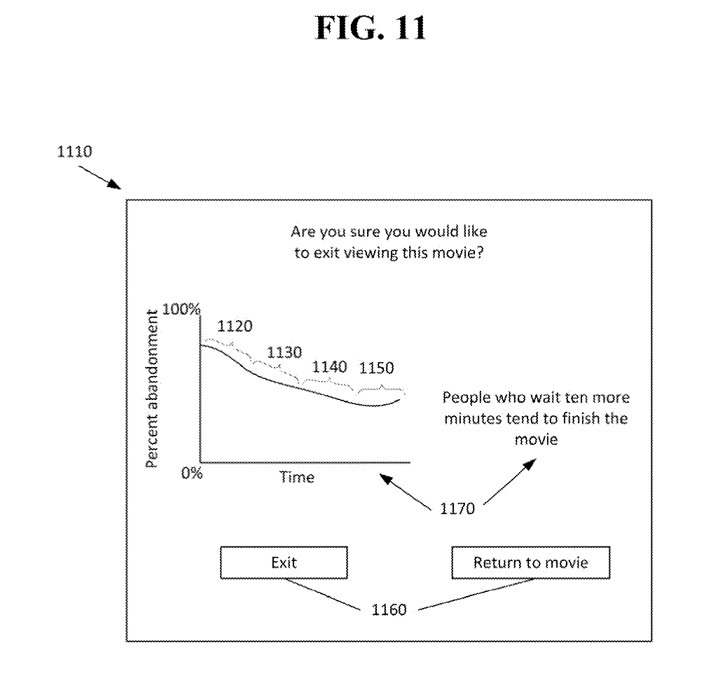

In some cases, a user may choose to abandon viewing content because it is uninteresting to the user. But, the user may not realize that analytic data indicates that people who arrive at a first maker in the content continue through to a second marker in the content a percentage of the time. If the analytic data is exposed or presented to the user, the user may decide to continue viewing the content instead of abandoning it. For example, upon detecting an abandonment event as described earlier, a window 1110 may appear that contains analytic data 1170 as shown in FIG. 11. The window may contain options to continue viewing the content or to exit viewing the content 1160. A graph may be shown that indicates an abandonment rate for the remaining, unviewed portion of the content. In the example shown in FIG. 11, the graph may indicate four segments 1120, 1130, 1140, and 1150. Each segment may be differentially colored or highlighted based on the analytic data (the percentage abandonment rate in this example). Textual analytic data may also be presented to indicate to the user that most people who watch ten more minutes of the content tend to finish it. A user decision may then be received by the option provided at the bottom of the screen 1160.

A user's friends may discontinue viewing a movie or abandon a movie and not return. In an implementation, a user's friends may share their video activity, including when the friend abandoned the movie, with the user and/or the user's friend may provide a comment about the movie that may be tagged to a particular interval of the movie (e.g., where the friend discontinued viewing the movie).

In some cases, a user would like to make a decision about whether to buy content based on a preview (e.g., a trailer, an excerpt, a screenshot, a rating, a review, etc.). In an implementation, analytic data showing, for example an abandonment rate of users may be provided to inform a user's rental or purchase of content. For example, below information about the content, an annotation or textual representation of analytic data may be provided to the user to indicate, for example, “People who watch fifteen minutes of this movie tend to watch the entire movie.” This may assist the user in deciding whether to consume the content or not and/or might cause the user to consume at least the first fifteen minutes of content and decide at that point in time whether or not to continue consumption of the content.

In some instances, a user may not know what content may be entertaining or what portions of content may be entertaining Completion statistics or analytic data may be provided based on an age group, location, friend group, etc. For example, a song that a user is previewing could be accompanied with an indication that it is currently being listed to by the user's friends and/or provide the user's friend's comments. The user may be informed that a song in the user's shopping cart has a very low play rate by other consumers. As another example, a movie that a user has ceased viewing for ten minutes may have a very high completion rate for people who watch the movie for at least fifteen minutes.

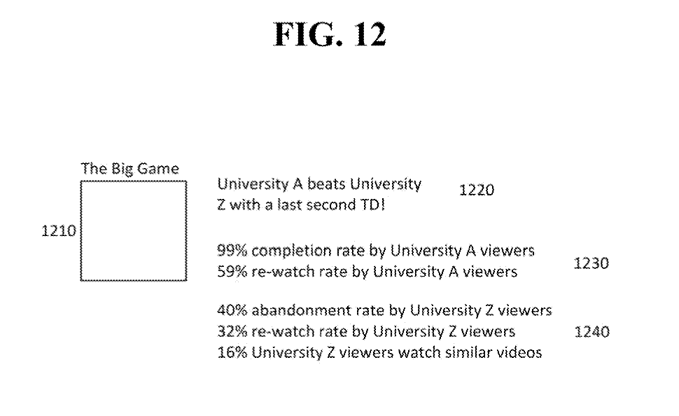

In an implementation, major filter differences and features for a user may be identified. For example, a user may be affiliated with a particular university and people from that university may tend to watch a particular video of the university winning on a last second touchdown pass. People from the university also tend to re-watch that video multiple times whereas individuals from the opposing school may tend to abandon the video without returning to watch it again. The major filter in this example would be individuals from the university that scored the winning touchdown as compared to people from the other school. This filter may be compared to other filters that show a significant different that are not necessarily connected. Content may be segmented as described earlier. The percentages of content that has been completed by consumers or users may be determined. The data may be smoothed as described earlier and it may be ranked and/or selected. The selected data may be provided to the user. An example of providing analytic data is provided in FIG. 12. The title of the video is “The Big Game” and a thumbnail of the video may be provided 1210. A summary of the video may be shown to the user 1220. Analytic data 1230, 1240 regarding the video may be displayed to show that individuals from University A tend to have a substantially higher completion rate for The Big Game video as compared with individuals from University Z. Other analytic data may be displayed such as the re-watch percentage for individuals associated with each university and/or what percentage of viewers from a particular university go on to watch videos similar to The Big Game.

In an implementation, analytic data may include completion metrics such as a percent read, watched, listened to of a book, a movie, or a song/album respectively. It may be organized by a particular chapter, scene, or song and filtered by information contained in a user profile such as an age, a location, an indicated interest, a time of day, etc. The analytic data may be based on a user action such as selecting or causing content to play, pause, stop, rewind, replay, or be purchased. The analytic data, therefore, may represent data about what users are doing with particular content items and filtering may allow enough variation or manipulation of the data so that the analytic data can inform a user's decision with respect to consume content or continue to consume content.

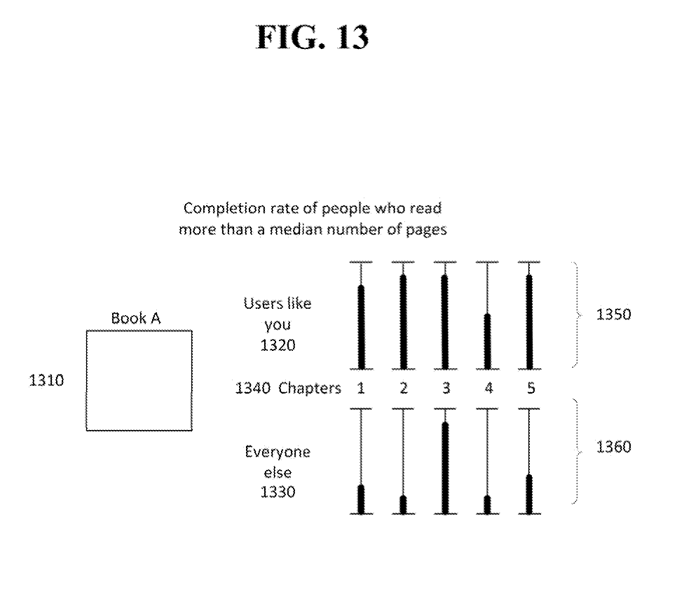

In some instances, a user may be informed that a fried liked a particular book or that a book has a high rating. The user also may benefit from additional analytic data that shows what other people like the user tend to do with the book. FIG. 13-16 show examples of implementations in which a completion rate for a given search result or discovery stream on a media store is provided. In FIG. 13, the completion rate for Book A, along with a thumbnail for Book A 1310, is shown for users whose profile matches, in at least one aspect, to that of the user 1320 and for those users whose profile does not match the user (or who were excluded from the analytic data shown for those users who match the user 1350) 1330. The analytic data 1350, 1360 may be broken down according to chapter 1340. The thicker lines indicate the completion rate for each chapter (e.g., the higher the line, the greater percentage of users who completed that particular chapter). A user, by viewing such data, can see that the analytic data that matches the user 1350 indicates that the user will likely enjoy the book. In contrast, other individuals whose profile did not match the user generally did not complete reading any of the five chapters of the book except chapter three.

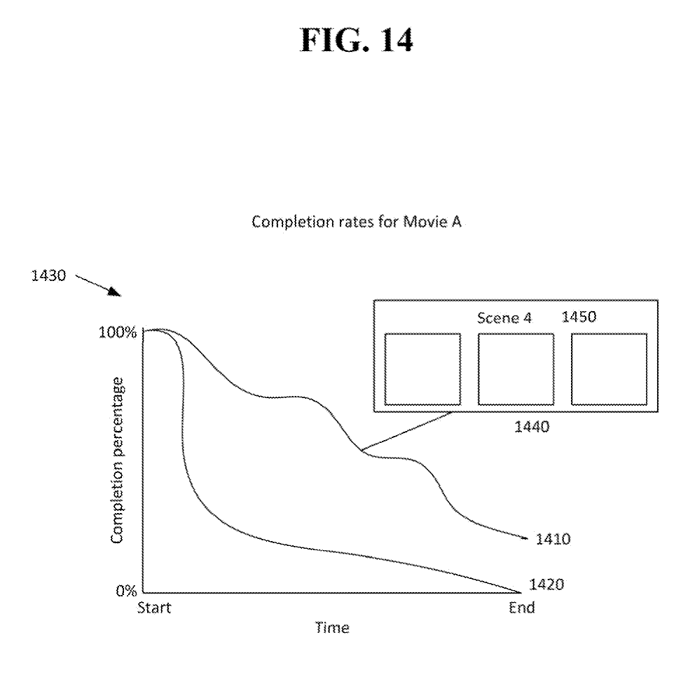

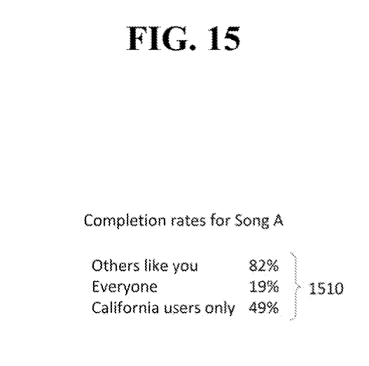

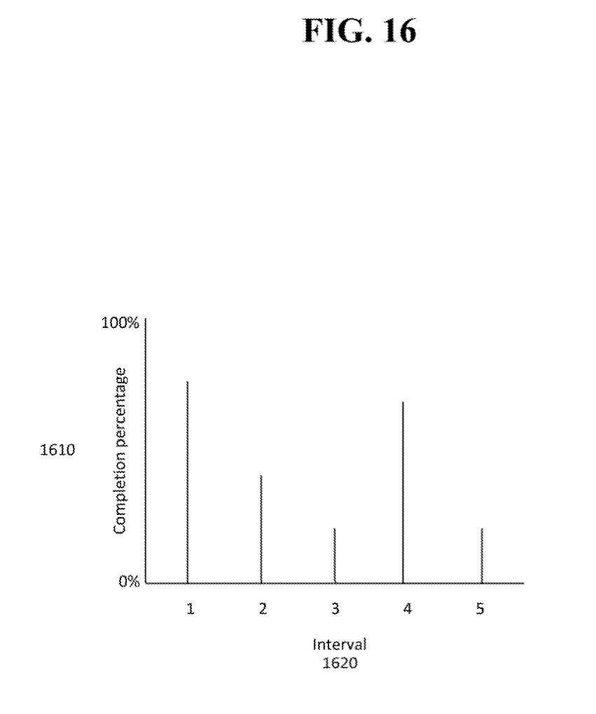

FIG. 14 shows an example of the completion rate for a movie 1430 for those individuals whose profiles match the user 1410 and those individuals whose profiles do not match the user 1420. The two lines shown in the graph 1410, 1420 may be highlighted in different colors to provide added visual contrast or otherwise labeled to clearly indicate to what they refer. A user may select a point on the graph and a window 1440 may appear that provides thumbnail images for a particular scene in the movie 1450. FIG. 15 shows an example of a completion rate for Song A. The analytic data 1510 may be presented to a user to indicate the completion rate for other users whose profiles match the user, all users irrespective of their individual profiles or characteristics, and California users only. FIG. 16 provides an example of a graphical representation of a completion percentage 1610 for users who consumed content such as a book or a movie. The content may be segmented into an interval such as a chapter or scene 1620. A completion percentage above 50% may indicate a particularly entertaining part of the content.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method, comprising:
obtaining a user profile for a user;
receiving a selection of media content based on a recommendation;
providing the selected media content for consumption by the user;
receiving an indication of an abandonment event that indicates discontinuation of consumption of the selected media content at a position in the selected media content;
based on the abandonment event, selecting, by a processor, analytic data, wherein the analytic data indicates a likelihood of continued consumption beyond the position in the selected media content by a plurality of users having profiles similar to the user profile, wherein the analytic data includes at least one of a completion percentage of content consumption by the plurality of users, a completion percentage for a plurality of segments of the content by the plurality of users, a satisfaction rating, and a click-through metric;
providing to the user, by the processor, an indication of the analytic data showing the likelihood of continued consumption of the media content by the plurality of users having profiles similar to the user profile; and
receiving an indication of a decision by the user to continue consumption of the selected media content beyond the position in the selected media content.

2. The method of claim 1, further comprising providing the recommendation of content to the user based on the user profile;

3. The method of claim 1, further comprising:
receiving a decision from the user; and
based on the received decision, modifying the analytic data.

4. The method of claim 1, further comprising:
receiving a decision from the user; and
based on the received decision, modifying the user profile.

5. (canceled)

6. The method of claim 1, wherein the analytic data is based on an action of the user.

7. The method of claim 1, wherein the indication of the abandonment event is selected from the group consisting of: a pause, a window close, and a browser action.

8. The method of claim 1, further comprising determining a social network associated with the user, wherein the analytic data is selected based on the social network.

9. The method of claim 8, wherein the analytic data comprises at least one comment from the social network.

10. A method, comprising:
segmenting content into a plurality of segments based on a predetermined interval;
determining analytic data for each of the plurality of segments;
receiving a selection of content from a user associated with a user profile;
receiving a request for analytic data corresponding to a portion of the plurality of segments;
determining a position of the user in the content;
responsive to the request and based on the user position in the content and the user profile, presenting the analytic data.

11. The method of claim 10, further comprising selecting a presentation style for the analytic data.

12. The method of claim 10, wherein the predetermined interval is selected from the group consisting of: a chapter, a scene, a page, a predetermined time, and a paragraph.

13. The method of claim 10, further comprising detecting an abandonment event, wherein the abandonment causes the request for analytic data.

14. The method of claim 13, wherein the indication of the abandonment event is selected from the group consisting of: a pause, a window close, and a browser action.

15. The method of claim 10, further comprising:
receiving a decision from the user; and
based on the received decision, modifying the analytic data;

16. The method of claim 10, further comprising:
receiving a decision from the user; and
based on the received decision, modifying the user profile.

17. The method of claim 10, wherein analytic data is selected from the group consisting of: a completion percentage of content consumption by a plurality of users, a completion percentage for a plurality of segments of the content by the plurality of users, a satisfaction rating, and a click-through metric.

18. The method of claim 10, wherein the analytic data is based on an action of the user.

19. The method of claim 10, further comprising determining a social network associated with the user, wherein the analytic data is selected based on the social network.

20. The method of claim 19, wherein the analytic data comprises at least one comment from the social network.

21. A system, comprising:
a database for storing at least one user profile;
a processor communicatively coupled to the database and configured to:
obtain a user profile for a user from the database;
receive a selection of media content based on a recommendation;
provide the selected media content for consumption by the user;
receive an indication of an abandonment event that indicates discontinuation of consumption of the selected media content at a position in the selected media content;
based on the abandonment event, select analytic data, wherein the analytic data indicates a likelihood of continued consumption of the media content beyond the position in the selected media content by a plurality of users having profiles similar to the user profile, wherein the analytic data includes at least one of a completion percentage of content consumption by the plurality of users, a completion percentage for a plurality of segments of the content by the plurality of users, a satisfaction rating, and a click-through metric; and
provide to the user an indication of the analytic data showing the likelihood of continued consumption of the media content by the plurality of users having profiles similar to the user profile; and
receive an indication of a decision by the user to continue consumption of the selected media content beyond the position in the selected media content.

22. The system of claim 21, the processor further configured to provide the recommendation of content to the user based on the user profile;

23. The system of claim 21, the processor further configured to:
receive a decision from the user; and
based on the received decision, modify the analytic data;

24. The system of claim 21, the processor further configured to:
receive a decision from the user; and
based on the received decision, modify the user profile.

25. (canceled)

26. The system of claim 21, wherein the analytic data is based on an action of the user.

27. The system of claim 21, wherein the indication of the abandonment event is selected from the group consisting of: a pause, a window close, and a browser action.

28. The system of claim 21, the processor further configured to determine a social network associated with the user, wherein the analytic data is selected based on the social network.

29. The system of claim 28, wherein the analytic data comprises at least one comment from the social network.
